(19) United States
(12) Patent Application Publication
(10) Pub. No.: US 2004/0039635 A1
(43) Pub. Date: Feb. 26, 2004

(54) Ticketing apparatus and method

(76) Inventors: Alexander N. Linde, Macclesfield (GB); Stephen K. Mills, Eastham (GB)

Correspondence Address: BERNHARD P. MOLLDREM, JR., 2ND FLOOR, MONROE BUILDING, 333 EAST ONONDAGA STREET, SYRACUSE, NY, 13202, US

(21) Appl. No.: 10/398,330

(22) PCT Filed: Oct. 4, 2001
(86) PCT No.: PCT/GB01/04418

(30) Foreign Application Priority Data
Oct. 6, 2000 (GB) 0024545.6

(51) Int. Cl. G06F 17/60

(52) U.S. Cl. 705/14; 235/375; 340/5.8

(57) ABSTRACT

In a first aspect there is provided an apparatus for ticketing, the apparatus including:

sending means for sending a ticket representation to a wireless device; and

verification means for verifying the validity of said ticket representation on said wireless device. The ticket representation may be just part of a complete set of ticket information which may be sent to the wireless device, e.g. the sending means may send some other ticket information along with (or instead of) the ticket representation to the wireless device.

This invention relates to an apparatus and method for ticketing. In particular, this invention relates to the provision of a ticket representation (hereinafter called a personal user identification (PUID) ticket) to a wireless device.

Many different types of tickets are widely provided either in exchange for money or free of charge, these tickets then being exchanged for goods, services or some other purpose. For example, a ticket may be purchased in order to gain entry into some location, for example a nightclub, sports club or theatre.

In locations such as a theatre, it is common for patrons to have purchased their tickets in advance. In order to do this, the patron will have to either collect the ticket from the theatre or alternatively, the ticket will be posted to the patron. One problem with this system is that it is often impossible or inconvenient for the patron to visit the theatre prior to the performance and the use of the postal system to deliver tickets means that patrons need to request tickets sufficiently far in advance to allow time for delivery.

At venues such as nightclubs, patrons usually arrive at the venue without a ticket and then purchase a ticket prior to entry. It is common for large queues to form outside such venues as many patrons will arrive and wish to enter the premises at the same time. The presence of these queues is unsatisfactory both to the patrons of the venue and also to the venue providers who often have to employ security personnel in order to maintain an orderly queue.

Furthermore, venues such as nightclubs often find it difficult to obtain information about their customer base as entrance ticket purchasers almost invariably pay on the door, in cash and therefore do not provide any details that are of use to the venue providers when assessing the customer base.

Other types of tickets are also used, for example, by retailers, to promote goods and services by providing free voucher tickets that can be exchanged for goods, services, free entry to venues etc. Promoters traditionally distribute these voucher tickets in magazines, newspapers and alternatively/additionally by hand. Therefore, unfortunately, the only people that are accessible to the promoters are those who read the appropriate newspapers or magazines or those that are present in the location where vouchers are being distributed by hand.

Another type of ticket is the loyalty ticket. Goods or service providers, such as supermarkets, provide customers with a loyalty ticket that can be presented by the customer whenever the retailer's goods or services are purchased such that the retailer credits the loyalty ticket with points that may have a cash value that can then be exchanged for further goods/services. This may not be a viable option for some retailers that do not have the required infrastructure.

Yet another type of ticket is a membership ticket issued by establishments such as libraries, sports clubs or video clubs. Traditionally, these membership tickets are provided as plastic or laminated cardboard cards. If a person belongs to many different establishments, it is necessary to carry a number of cards and this can be cumbersome and inconvenient.

The present invention aims to provide a system that can be used to ameliorate the above problems.

In a first aspect there is provided an apparatus for ticketing, the apparatus including:

sending means for sending a ticket representation to a wireless device; and

verification means for verifying the validity of said ticket representation on said wireless device.

Ticket representation preferably means any representation, encoded, encrypted or otherwise, graphical, numerical or otherwise that purveys sufficient detail to allow a specific, ticketed transaction to occur. The ticket representation is preferably intended to replace the need for any other form of ticket or receipt in the ticketed transaction.

The ticket representation may be just part of a complete set of ticket information which may be sent to the wireless device, e.g. the sending means may send some other ticket information along with (or instead of) the ticket representation to the wireless device.

Ticket representation (and/or any other ticket information) will be referred to hereinafter as a personal user identification (PUID) ticket.

In preferred embodiments, the sending means are located at a first location, for example a PUID ticket issue centre, whilst the verification means are located at a second location, the second location being e.g. the point at which a ticket holder redeems the ticket for the goods, services etc. of a ticket redeemer. In many applications the first and second location will be remote from one another.

Preferably, the sending means includes transmitter means which may use e.g. a system of circuit-switched or packet-based communication that can be used between a wireless device and a PUID generation source. At the present time, this is preferably GSM using SMS, but it could also include TDMA, CDMA, GPRS, UMTS, EDGE or any other wireless system.

In preferred embodiments, the sending means also includes coding means for coding the PUID ticket prior to sending the PUID ticket to the remote wireless device.

The coding means preferably creates an encrypted code, e.g. a numerical code to be used as a PUID ticket.

In preferred embodiments, the PUID ticket is coded by the coding means and represented in a barcode format. In especially preferred embodiments, the EAN-8 and CODE 25 INTERLEAVED barcode formats are used due to their compact size. Alternatively, a two-dimensional barcode such as PDS417 may be used to represent the PUID ticket.

In some applications, the sending of the PUID ticket will be subject to receipt of a request and/or payment for the PUID ticket. In these applications, the sending means preferably includes means for receiving a request for a PUID ticket and/or means for receiving payment for a PUID ticket.

The request may be made from a wireless device having a WML (WAP) application.

The sending means preferably includes means for confirming delivery of the PUID ticket to the wireless device.

In a second aspect there is provided sending means as described hereinbefore.

Preferably, each PUID ticket sent to a wireless device is a unique ticket (e.g. contains a unique code or reference number). This is for security reasons e.g. to prevent forgery of tickets.

The wireless device is most preferably a mobile phone but could be any wireless device such as a palm top computer or some other device.

The wireless device has means for receiving a PUID ticket. Furthermore, the wireless device preferably has storing means to store the PUID ticket.

The wireless device preferably has display means e.g. a screen for displaying the PUID ticket e.g. as a barcode.

In embodiments where the PUID ticket is a barcode or some other graphical image, the wireless device preferably has a usable screen area of at least 65 pixels wide and 20 pixels high which can be drawn to in graphics mode i.e. pixel-by-pixel rather than only using alpha numeric characters.

In a third aspect there is provided a wireless device as described hereinbefore.

In preferred embodiments, the wireless device includes software that allows the receipt and the display of the PUID ticket. In especially preferred embodiments, the software also allows storage of the PUID ticket. Examples of software and standards suitable for this purpose include Magic4 Client, Nokia Smart Messaging, Enhanced Messaging Service (EMS), Wireless Mark-up Language (WML) or Compact HTML (CHTML).

In some embodiments, the PUID ticket becomes invalid after verification, e.g. a PUID ticket for entrance into a theatre may become invalid once redeemed so that the ticket holder can only make one visit unless another ticket is purchased. In these embodiments, the software provides for removal of the PUID from the wireless device after verification of the ticket. Magic4 Client software allows for such removal.

In other applications, e.g. loyalty tickets or membership tickets, it is desirable for the PUID ticket to remain on the wireless device for the duration of the ticket holder's relationship with the ticket redeemer.

In a fourth aspect there is provided software for a wireless device as described herein before.

The verification means may include reading means to read the PUID ticket, for example from the display means of the wireless device or by otherwise accessing the ticket representation from the wireless device. Other methods of accessing the ticket representation include IrDA and radio methods.

Preferably, the verification means includes decoding means for decoding a coded PUID ticket.

In embodiments where the PUID ticket is encoded in a barcode format, the reading and decoding means are preferably a barcode reader of the type well known in the art.

In some applications i.e. low security applications the verification means uses a checksum algorithm to validate the PUID ticket and then stores a list of PUID tickets that have already been validated so that they cannot be used again.

In other embodiments, the verification means includes a database which contains details of valid PUID tickets. This database is accessible to the ticket redeemer so that it can be used to determine whether a PUID ticket included in the wireless device is valid. The database may be at the second location and e.g. on a computer system at the ticket redeemer's premises. Alternatively, the database may be at the first location and e.g. on a computer system at the ticket issue centre. This database may be updated automatically, e.g. each time a PUID ticket is issued or the database may be up-dated manually.

Preferably, the verification means also includes indication means to indicate the result of verification i.e. whether or not the ticket holder has a valid PUID ticket.

The indication means may be a visible indication means, e.g. computer screen that displays a message and/or may be an audible indication means, e.g. a buzzer or alarm.

In some embodiments, for example, in embodiments where the PUID ticket is in the form of an encrypted numeric code, the verification means are included within the wireless device, for example in the form of a software application that recognises the encryption methodology used to encrypt the PUID ticket; separate verification means are not required. Typically, a version of Public-Key/Private Key encryption may be used to encrypt the PUID ticket.

In these embodiments, the indication means are preferably the display screen and audible tones of the wireless device itself.

Preferred embodiments have accounting means associated with the verification means so that the number of tickets verified as valid can be used for accounting purposes.

In a fifth aspect, there is provided verification means as described hereinbefore.

In a sixth aspect there is provided a method for ticketing, the method including the steps of:

sending a ticket representation to wireless device; and

verifying the validity of the ticket representation presented on the wireless device.

In preferred embodiments, the sending step is carried out at a first location, e.g. a ticket issue centre, whilst the verifying step is carried out at a second location, the second location being the premises of the ticket redeemer. In many applications the first and second locations will be remote from one another.

In some applications, e.g. the purchase of a theatre or night club ticket, the method involves sending the PUID ticket in response to a request by the prospective ticket holder.

The request may be made via any means, for example via the wireless device, a telephone or the Internet.

In many instances, it is necessary for the ticket holder to pay for the PUID ticket. This may be done by the ticket requester providing credit/debit card details to the ticket issuer or, alternatively, if the wireless device is a mobile phone, the cost of the ticket may be charged to the ticket requester's phone account. Alternatively, the ticket requester may have previously provided credit/debit card details to the ticket issuer so that, upon request of a ticket, the requester provides a pre-assigned PIN number to the issuer in order to allow the cost of the PUID ticket to be charged to the payment card.

In other applications, e.g. issue of promotional voucher tickets, the method involves sending a ticket to prospective ticket holders without receiving a specific request or payment.

The PUID ticket is preferably sent using a circuit-switched or packet-based communication system, such as those described hereinbefore.

In preferred embodiments, the method also includes the step of coding and preferably the step of encrypting the PUID ticket prior to sending. For example, the PUID ticket may be encoded in a barcode format or in an numerical format.

Preferably, the method further includes the step of ascertaining that the PUID ticket sent has been received by the wireless device. For example, the GSM and SMS sending means includes delivery receipt means as standard and this can be used to ascertain whether a PUID ticket has been received.

In preferred embodiments, the verifying step includes the step of reading and, if necessary, decoding the coded PUID ticket. In cases where the PUID ticket is coded in bar code format, reading and decoding may be achieved using a standard barcode reader as is well known in the art.

The verification step preferably also includes the step of comparing the PUID ticket on the wireless device with a set of valid PUID tickets contained in a database. This database may be physically located at the first location e.g. on a computer system managed by the ticket issuer or embedded in the means used to read and/or decode the PUID ticket, or at the second location e.g. on a computer system on the ticket redeemer's premises.

The method preferably includes the step of updating this database in order to maintain a searchable list of valid PUID ticket details. The updating may be carried out automatically, e.g. each time a PUID ticket is sent or, alternatively, the database may be updated by manual input of the valid PUID ticket details.

Some embodiments, for example embodiments where the PUID ticket is an encrypted numerical code, may not require the use of a database in the verification step. In these embodiments, the verification step may be carried out by the ticket redeemer inputting a validation code into the wireless device and if the validation code matches the PUID ticket, the ticket is considered to be valid.

Other embodiments that do not require use of such a database involve use of a checksum algorithm, the verification means storing a list of tickets that have already been validated so that they cannot be used again.

The verification step preferably also includes the step of indicating whether or not the PUID ticket presented on the wireless device is valid or not. This may be done using audible or visual indication means as described hereinbefore.

In some embodiments, the method preferably, includes removing the PUID ticket from the wireless device after verification. This will be appropriate when each ticket can only be used once, e.g. an entrance ticket to a theatre or night club.

In cases where the ticket is to be re-used, such as in loyalty ticket schemes or membership tickets, it is not desirable to remove the ticket after verification.

In high security applications of the present invention, after the PUID ticket had been read by the ticket redeemer, the method includes the step of carrying out a security check. This step includes communication between the verification means and a computer system at the PUID ticket issue centre, the computer system checking that the PUID ticket has been presented to the correct ticket redeemer and on the correct wireless device. If these details are correct, the computer system then sends a personal identification number (PIN) request to the ticket holder's wireless device. The PIN is then input by the ticket holder and the computer system checks the validity of the PIN. Only if the PUID ticket is valid and the PIN is correct is the ticket holder entitled to use the ticket.

Preferred embodiments of the invention will now be described with reference to the following figures in which:

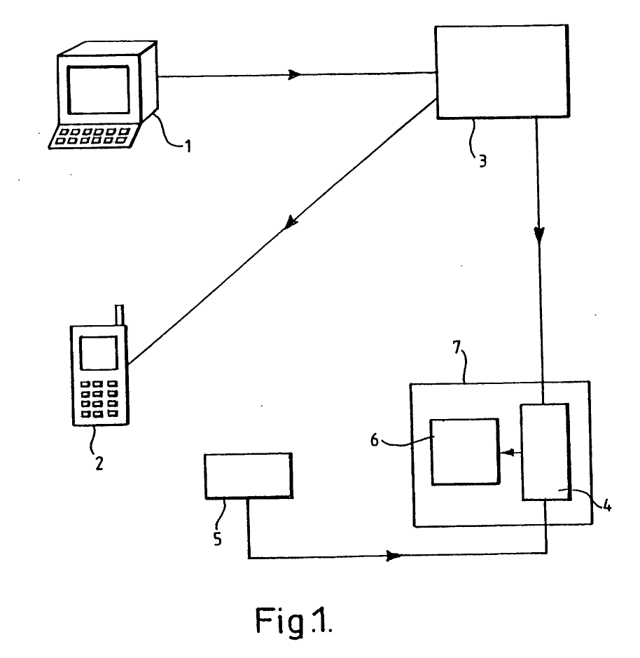

FIG. 1 shows a schematic representation of a first preferred embodiment;

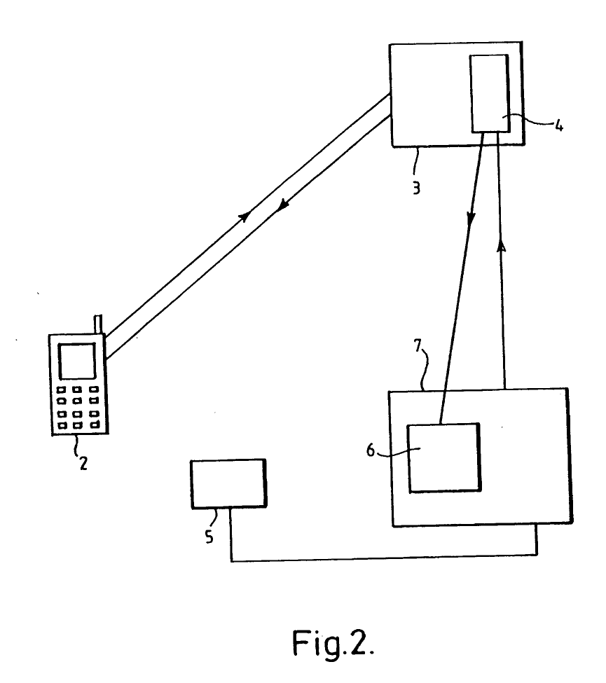

FIG. 2 shows a schematic representation of a second preferred embodiment;

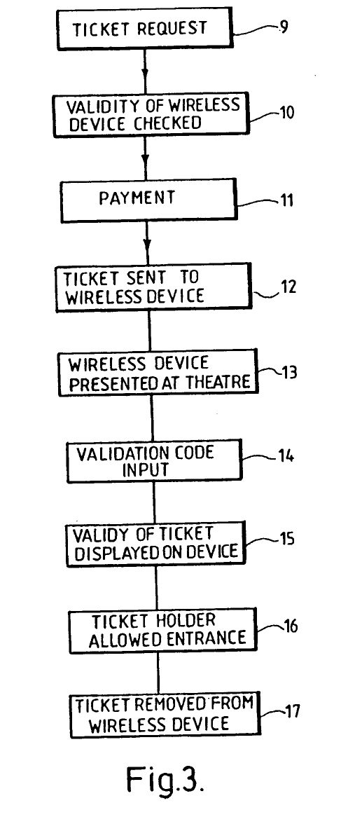

FIG. 3 shows a flow chart for a third preferred embodiment;

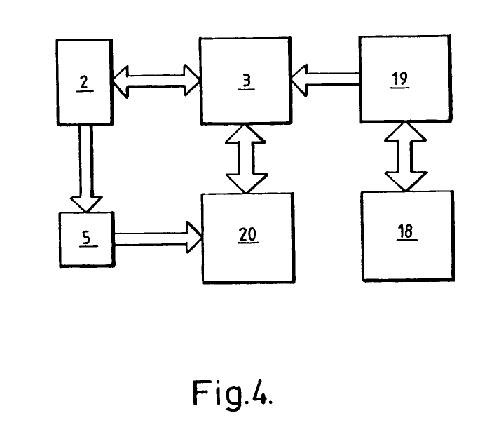

FIG. 4 shows a schematic representation of a fourth preferred embodiment of the present invention, this embodiment being a high security application.

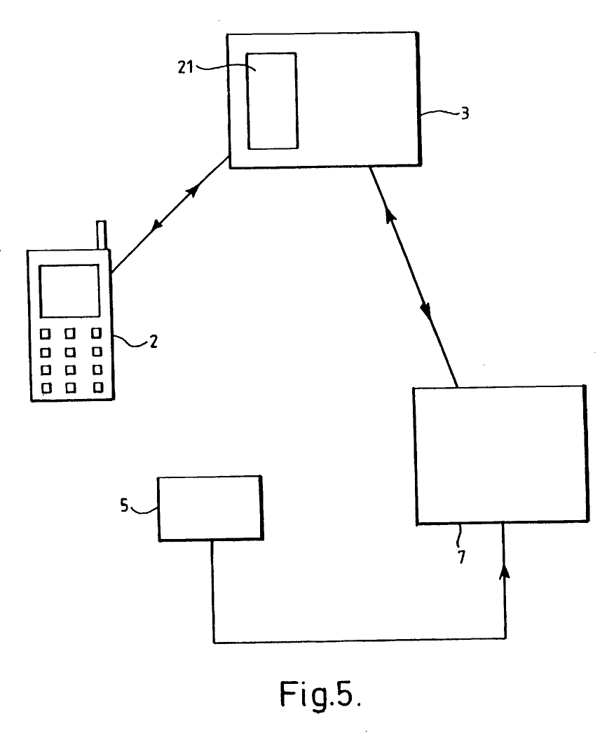

FIG. 5 shows a schematic representation of a fifth preferred embodiment of the present invention.

FIG. 1 shows a computer, 1, having an Internet connection.

The prospective ticket holder uses the Internet to access a web page relating to the venue for which a ticket is required. To purchase a ticket, various details are entered on the web-site including the telephone number assigned to the prospective ticket holder's mobile phone, 2.

This information is received by a ticket issue centre, 3.

The centre carries out a validation procedure to ensure that the mobile phone, 2, is capable of receiving a PUID ticket. Once this validation is complete, the prospective ticket holder is asked to provide financial details to allow payment for the PUID ticket.

Once payment has been processed, the centre, 3, formulates a PUID ticket in e.g. EAN-8 barcode format.

This PUID ticket is then transmitted to the mobile phone, 2, using a communication system such as GSM using SMS.

Prior to the event for which the ticket is valid, the issue centre, 3, compiles a list of all valid PUID ticket tickets and sends this, by e-mail, fax or the Internet, to the venue of the event such that a database, 4, present on a computer system, 7, at the venue can be updated with details of the valid tickets.

On arriving at the event, the ticket holder presents the mobile phone, 2, bearing the PUID ticket and the PUID ticket is scanned using a scanner, 5. This scanner then decodes the information in the barcode and communicates with the database, 4, to check whether the PUID ticket presented on the mobile phone, 2, is valid.

If the PUID ticket is valid, then the VDU, 6, of the computer system, 7, indicates that the PUID ticket is valid by displaying a ‘VALID’ message. In this case, the PUID ticket holder is allowed access to the venue.

In the event that the PUID ticket is invalid, the computer system will display an ‘INVALID’ message on the VDU, 6, and a buzzer will sound. In that event, the PUID ticket holder is barred from entry to the venue.

FIG. 2 shows a schematic representation of a loyalty card system according to a second preferred embodiment of the present invention.

If a customer wishes to join a retailer's loyalty ticket scheme, the customer telephones a given telephone number and is connected to the issue centre, 3. The customer will then provide the telephone number of their mobile telephone, 2.

The issue centre checks whether the specified mobile phone is capable of receiving a PUID ticket and if it is, the centre, 3, formulates a PUID ticket e.g. in CODE 25 INTERLEAVED barcode format. This format is a special form of the standard Code 25 barcode designed to be more compact.

This PUID ticket is then transmitted to the mobile phone, 2, using a communication system such as GSM using SMS.

The centre maintains a database, 4, containing details of valid PUID tickets. This database is updated automatically or manually each time a PUID ticket is distributed.

To make a purchase, the ticket holder presents the mobile phone, 2, bearing the PUID ticket to the retailer and the PUID ticket is scanned using a barcode reader, 5. This reader then decodes the information in the barcode and a computer system, 7, at the retailers premises communicates with the remote database, 4, to check whether the PUID ticket presented on the mobile phone, 2, is valid. If the PUID ticket is valid, then the retailer is given an indication of the validity. This indication may appear as a message on a VDU, 6, of the retailer's computer system and/or as an audible indication such as a buzzer.

If a valid PUID ticket is presented, the retailer may then award points to the ticket holder, the number of points awarded usually being dependent on the amount of money spent by the ticket holder.

FIG. 3 shows a flow chart for a third preferred embodiment for use at a theatre.

A prospective ticket holder requests, 9, a ticket, for example using the Internet as in the first preferred embodiment or using a telephone as in the second preferred embodiment.

This request is dealt with by the issue centre who check the validity, 10, of the prospective ticket holder's mobile phone. Assuming that the mobile phone is capable of receiving the ticket, the cost of the ticket is charged, 11, to the prospective ticket holders mobile phone account.

The centre then formulates an encrypted numerical PUID ticket that is sent, 12, to the mobile phone.

On arrival at the theatre, the ticket holder presents, 13, the mobile phone to the ticket redeemer who is in possession of a validation code. The validation code is input, 14, into the mobile phone by the ticket redeemer and if the input code matches the encrypted PUID ticket contained in the mobile phone, then the display screen of the mobile phone displays, 15, an indication that the ticket is valid. If the ticket is valid, the ticket holder is permitted to enter, 16, the theatre.

After verification, the PUID ticket is removed, 17, from the mobile phone.

FIG. 4 shows a schematic representation of a fourth embodiment that has a high security application.

A prospective ticket holder, 18, accesses an e-commerce site, 19, selects a product and requests a ticket. The ticket requester enters the telephone number assigned to their mobile phone, 2 and the cost of the ticket is charged to the requester's mobile phone account.

The e-commerce site, 19, sends the ticket details to the ticket issuing centre, 3. The centre, 3, checks that the mobile phone, 2, is registered with the ticket issuing centre, all registered mobile phones having been assigned a personal identification number (PIN) code.

If the mobile phone, 2, is unregistered, the ticket issuing centre, 3, informs the e-commerce site, 19, and the requester is prompted to register their mobile phone, details.

The ticket issuing centre, 3, then encodes PUID ticket, formats the electronic representation and sends this to the mobile phone, 2.

When the ticket holder presents their mobile phone to the ticket redeemer, 20, the electronic representation is scanned using a scanner, 5. The scanned code is decoded and sent, to the ticket issuing centre, 3, for validation.

The ticket issuing centre, 3, checks that the ticket has been presented on the correct mobile device and has been presented to the correct ticket redeemer. A PIN request is then sent to the mobile phone, 2.

The ticket holder must then enter the PIN code on the mobile phone, 2, and the PIN is returned to the ticket issuing centre. If the PIN is valid, the ticket issuing centre, 3, sends confirmation to the ticket redeemer, 20, that the ticket is valid and the ticket redeemer may then release the product to the ticket holder.

FIG. 5 shows a schematic representation of a further preferred embodiment which utilises WAP technology.

A user having a WAP mobile phone, 2, connects to a ticket issuing centre, 3, using either the WAP mobile phone or a standard computer Internet connection. The user may already be registered with the ticket issuing centre or alternatively, may be required to register at this time.

The user selects a product or service that he wishes to purchase. If payment is required, the user authorises payment and is then informed that the transaction has been successful.

At a later time, when the user wishes to redeem the ticket, the user connects to the WAP service, 21, of the ticket issuing centre, 3, using their WAP capable mobile phone, 2. After the user has been authorised, preferably automatically or using a PIN code, the user is presented with the option to display any purchased tickets. The user selects the relevant ticket and selects the “show option”. A barcode is then displayed on the screen of the mobile phone, 2, and is read by a barcode scanner, 5, by the ticket redeemer.

The ticket redeemer's computer system, 7, which may be a fixed or a mobile device, communicates with the ticket issuing centre to confirm that the ticket is valid.

The ticket issuing system logs accounting information about the transaction and if the ticket is valid, a success message is returned to the redeemer's computer system, 7.

The ticket is then removed from the user's list of purchased tickets.

The ticket redeemer then releases the product or service to the user.

These embodiments are given by way of example only and variations will be apparent to those skilled in the art.

1. An apparatus for ticketing, the apparatus including:
sending means for sending a ticket representation to a wireless device; and
verification means for verifying the validity of said ticket representation on said wireless device.

2. Apparatus according to claim 1 wherein the sending means are located at a first location, and the verification means are located at a second location remote from the first location, the second location being the point at which a ticket holder redeems the ticket for goods or services.

3. Application according to claim 1 or claim 2 wherein the sending means includes transmitter means which use a system of circuit-switched or packet-based communication that can be used between a wireless device and a ticket representation generation source.

4. Apparatus according to claims 1-3 wherein the sending means includes coding means for coding the ticket representation prior to sending the ticket representation to the remote wireless device.

5. Apparatus according to claim 4 wherein the ticket representation is coded by the coding means in a barcode format.

6. Apparatus according to any of the above claims wherein the sending means includes means for receiving a request for a ticket and/or means for receiving payment for a ticket.

7. Apparatus according to any of the above claims wherein the sending means includes means for confirming delivery of the ticket to the wireless device.

8. Apparatus according to claims 1-7 wherein the verification means includes reading means to read. 9.

9. Apparatus according to claims 1-8 wherein the verification means includes decoding means for decoding a coded ticket.

10. Apparatus according to claim 9 wherein the verification means includes a database which contains details of valid PUID tickets.

11. Apparatus according to claims 1-10 wherein the verification means includes indication means to indicate the result of verification.

12. Sending means as claimed in any of claims 1-11.

13. A wireless device including means for receiving a ticket representation and storing means to store the ticket representation.

14. A wireless device according to claim 13 including display means for displaying the ticket.

15. A wireless device according to claim 13 or 14 including software that allows the receipt and the display of the ticket.

16. A method for ticketing, the method including the steps of:
sending a ticket representation to wireless device; and
verifying the validity of the ticket representation presented on the wireless device.

17. A method according to claim 16 wherein the sending step is carried out at a first location, whilst the verifying step is carried out at a second location remote from the first, the second location being the premises of the ticket redeemer.

18. A method according to claims 16-17 including the step of coding the ticket prior to sending.

19. A method according to claims 16-18 including the step of ascertaining that the ticket sent has been received by the wireless device.

20. A method according to claims 16-19 wherein the verifying step includes the step of reading and, if necessary, decoding the coded ticket.

21. A method according to claims 16-19 wherein the verification step also includes the step of comparing the ticket on the wireless device with a set of valid tickets contained in a database.

22. A method according to claim 21 including the step of updating the database in order to maintain a searchable list of valid ticket details.
